(19) United States
(12) Patent Application Publication
(10) Pub. No.: US 2018/0371195 A1
(43) Pub. Date: Dec. 27, 2018

(54) PRODUCTION OF FIBER COMPOSITE MATERIALS

(71) Applicant: LANXESS DEUTSCHLAND GMBH, KOLN (DE)

(72) Inventors: DOMINIC FUCHS, KOLN (DE); MICHAEL WITT, ECKERSDORF (DE); JURGEN KNAUP, KOLN (DE)

(73) Assignee: LANXESS DEUTSCHLAND GMBH, KOLN (DE)

(21) Appl. No.: 16/063,381

(22) PCT Filed: Nov. 29, 2016
(86) PCT No.: PCT/EP2016/079133

§ 371 Date: Jun. 18, 2018

(30) Foreign Application Priority Data
Dec. 18, 2015 (EP) 15201334.8
Aug. 29, 2016 (EP) 16186129.9

(51) Int. Cl. C08J 5/24; B29C 70/30

(52) U.S. Cl. CPC C08J 5/24; B29K 2309/08; B29C 70/30

(57) ABSTRACT

The invention relates to a process for the production of fiber composite materials via specific application of monomer mixtures to a surface of a fiber material and subsequently polymerization.

The invention relates to a process for the production of fiber composite materials via specific application of monomer mixtures to a surface of a fiber material and subsequently polymerization.

### PRIOR ART

Thermoplastic composite materials reinforced by continuous-filament fiber provide the possibility of replacing metallic materials and, in particular in automobile construction or else in applications in the Consumer Electronics Sector (CES), realizing sustainable, cost-effective light construction.

Thermoplastic composite materials can be deformed by heating. It is thus possible, by starting from semifinished sheet products known as composite sheets or organopanels, to produce, at low cost and with a cycle time that permits mass production, complex composite hybrid components that require no further downstream operations.

For the purposes of the invention, “semifinished products” or “organopanels” are impregnated and consolidated fiber-reinforced composite materials amenable to thermal deformation in downstream operations.

The particular properties of composite sheets are based on complete sheathing of each individual fiber by the thermoplastic matrix. Impregnation of the semifinished fiber product by polyamide 6 (PA 6) is nowadays preferably achieved in heated twin-belt presses. For this, the polymer is heated until it becomes molten, and is introduced under high pressure into the dry semifinished fiber product. The high melt viscosities of molten PA 6 are disadvantageous here because they restrict the speed of the process to an extent depending on the fiber material to be impregnated.

EP 791618A2 describes an alternative process for the impregnation of dry reinforcement-fiber structures by an activated lactam melt and subsequent polymerization to give PA 6. Here, the impregnation requires significantly lower press pressures and press times, because the monomer melt has low viscosity.

The lactam here is mixed in the molten state with the activator and the catalyst and optional additives, and this activated melt is then brought into contact with the reinforcement-fiber structure and impregnates same, and the monomeric lactam is then polymerized in situ to give the matrix of the plastics composite.

EP 791618A2 does not, however, describe how the activated melt is metered, how the activated melt is applied to the reinforcement-fiber structure, or the manner of impregnation and consolidation to give a composite material. A fundamental disadvantage of said process is that, because of a tendency toward polymerization at temperatures above the melting point of caprolactam, once the activated caprolactam melt has been prepared it readily polymerizes, and the resultant polymers cause problems in the supply lines.

Polymerization therefore results in deposits on walls and/or blockages during continuous operation over prolonged periods, at the mixing unit, at the supply lines leading to the actual application unit, and at the application unit itself. This leads to problems such as production stoppages in large industrial production plots.

In WO2013/174943, fiber-reinforced polyamides are reacted in what is known as the two-pot process, where mixtures of catalyst and lactam, and also activator and lactam, are first produced separately from one another in the form of liquid melts, and are then mixed with one another and subsequently polymerized in a casting mold in the presence of reinforcement fibers.

WO 2014086757 describes a quite different concept which, however, is likewise based on direct polymerization of an activated caprolactam melt.

Here, an activated caprolactam melt capable of polymerization is first converted by cooling to the solid, pulverulent state.

Accordingly, the powder already comprises activator, catalyst and optionally additives, and is directly deposited on the sheet-like reinforcement-fiber structure. A subsequent treatment under elevated pressure at a temperature at which the mixture of the components becomes flowable first impregnates the fiber material and then brings about polymerization.

The requirement here for prior production of this solid, polymerization composition in a complicated process is disadvantageous. EP2012062792 describes a possible method of production of a suitable pulverulent composition of this type, where an activated lactam melt is introduced by way of a nozzle into a spray tower, where it is cooled by means of inert gas and thus solidifies.

However, these processes are complicated by an additional step of this type, and are energetically disadvantageous because the lactam melt requires repeated successive melting and conversion back to the solid state by cooling.

Specifically, the mixing takes place in the molten state, and the melt is then cooled and treated to give particles of suitable size which then require remelting for the actual impregnation of the reinforcement-fiber structure.

It was an object to find a process which can produce fiber composite materials and which on the one hand provides good composite materials and on the other hand overcomes the disadvantages of the prior art, in particular avoids unnecessary alternating melting and solidification procedures, and moreover preferably permits problem-free operation in large industrial plants, without blockage of pipelines, mixers or applicator units by local accumulations of polymer contaminants, and without functional impairment due to formation of deposits on walls.

Surprisingly, a process for the production of a fiber composite material has been found, where:
a) the following are applied to the surface of a fiber material:
   a1) a monomer mixture that is liquid at the application temperature, comprising a cyclic amide and activator, and
   a2) a monomer mixture that is liquid at the application temperature, comprising a cyclic amide and a catalyst
   at a temperature above the melting point, and
b) the monomer mixtures applied in step a) are polymerized at a temperature of from 120 to 300° C.,
   characterized in that the average droplet size of the respective monomer mixtures a1) and a2) is less than 500 μm, particularly lower than 200 μm, in particular in the size range from 10 to 100 μm.

The two monomer mixtures are self-evidently different from one another. In a preferred embodiment, the maximal quantity of catalyst in the monomer mixture a1) is less than 0.1% by weight, in particular less than 0.01% by weight, based on the mixture, and the maximal quantity of activator in the monomer mixture a2) is less than 0.1% by weight, in particular less than 0.01% by weight, based on the mixture.

The mixtures a1) and a2) here can be applied in succession or simultaneously. The melting point of the respective monomer mixture a1) and a2) here means the melting point under standard pressure.

Fiber Material

The expression “fiber material” used for the purposes of the present application preferably means a material which takes the form of semifinished fiber product and is preferably selected from a group of woven fabrics, laid scrims inclusive of multiaxial laid scrims, knitted fabrics, braided fabrics, nonwoven fabrics, felts, and mats, and mixtures and combinations of two or more of these semifinished fiber products.

For the production of semifinished fiber products, the required fibers are bonded to one another in a manner such that at least one fiber or one fiber strand is in contact with at least one other fiber or one other fiber strand, thus forming a continuous material. Alternatively, the fibers used for the production of semifinished fiber products are in contact with one another in a manner that forms a continuous mat, fabric, textile or similar structure.

The expression “weight per unit area” describes the mass of a material as a function of the area, and for the purposes of the present invention relates to the dry fiber layer. Weight per unit area is determined in accordance with DIN EN ISO 12127.

The abovementioned textile fiber structures can have one or more plies, and can also be used for component production in various combinations in relation to textile sheet, fiber type and quantity of said fiber. It is preferably multiaxial or other laid scrims or (multiaxial) braided fabrics or woven fabrics, where these consist of two or more plies, preferably from 2 to 10.

Fibers present in the fiber materials used are preferably those made of inorganic minerals such as carbon, for example in the form of low-modulus carbon fibers or high-modulus carbon fibers, silicatic and non-silicatic glasses of a very wide variety of types, boron, silicon carbide, metals, metal alloys, metal oxides, metal nitrides, metal carbides, and silicates, and also organic materials such as natural and synthetic polymers, for example polyacrylonitriles, polyesters, polyamides, polyimides, aramids, liquid-crystal polymers, polyphenylene sulfides, polyetherketones, polyetheretherketones, polyetherimides, cotton, cellulose and other natural fibers, for example flax, sisal, kenaf, hemp, abaca. Preference is given to high-melting-point materials, for example glasses, carbon, aramids, potassium titanate, liquid-crystal polymers, polyphenylene sulfides, polyetherketones, polyetheretherketones and polyetherimides, particular preference being given to glass fibers, carbon fibers, aramid fibers, steel fibers, ceramic fibers and/or other sufficiently temperature-resistant polymeric fibers or filaments.

It is preferable to use fiber materials made of glass fibers and/or carbon fibers, particularly those made of glass fibers.

The fiber material made of carbon fibers is preferably a woven fabric with weight per unit area greater than 100 g/m².

The fiber material made of glass fibers is preferably a woven fabric. The weight per unit area of the fiber material made of glass fibers is preferably greater than or equal to 200 g/m², particularly preferably greater than or equal to 250 g/m². In a preferred embodiment of the invention, combinations of fiber material made of carbon fibers and fiber material made of glass fibers are used. Preference is given to fiber material combinations or semifinished fiber products comprising carbon fibers in the external plies and glass fibers in at least one internal ply.

The content of fiber materials in the fiber composite material to be produced in the invention is preferably in the range from 20 to 75% by volume, particularly preferably in the range from 40 to 65% by weight.

The process of the invention permits very good impregnation of the reinforcement fibers with economically acceptable polymerization times and formation of products with good mechanical properties.

For the purposes of the present invention, “impregnated” means that the monomer mixtures a1) and a2) respectively penetrate into the depths and cavities of the fiber material or semifinished fiber product and wet the fiber material. With the aid of the process of the invention it is possible to produce fiber composite materials with high fiber content.

Drying/Pretreatment of the Fiber Material

The residual moisture content of the fiber material used is preferably less than 5% by weight, preferably less than 1% by weight and in particular less than 0.1% by weight.

In order to ensure this, the fiber material used is preferably treated with hot air, the temperature of which is preferably from 60 to 200° C., in particular from 100 to 170° C., before application of the monomer mixtures a1) and a2). The dew point of the hot air here is preferably below 0° C., in particular below −18° C. and very particularly below −30° C.

The hot-air treatment particularly preferably takes place in two stages, where in a first stage, in the air-drying procedure, the fiber material is treated with hot air, and in particular hot air flows through the fiber material. In a second stage, which is preferably spatially downstream, the hot-air treatment preferably takes place by the air-circulation method, where the hot air is maintained at a constant, low moisture content by use of an absorber or by physical measures such as freezing to remove moisture.

The optional upstream first air-drying stage ensures that the quantity of moisture introduced into the second stage is not greater than the second stage can remove, for example in continuous operation.

It is preferable in both stages to use perforated substrate materials, in particular metal-sheet substrate materials, as underlay, or in the preferred case of a continuous process for transport of the fiber material through the individual stages. In this case, the hot air is preferably passed through said perforated underlays of the fiber material.

It is particularly preferable in the first stage to dry the fiber material by the air-drying process to a residual moisture content below 0.5% by weight.

a1)

It is preferable to use, as cyclic amide of component a1), an amide of the general component (I),

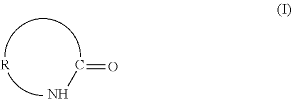

where R is a C3-C13-alkylene group, in particular a C5-C11-alkylene group.

Suitable cyclic amides of component a1) are in particular lactams of the formula (I) such as ε-caprolactam, 2-piperidone (δ-valerolactam), 2-pyrrolidone (γ-butyrolactam), enantholactam, laurolactam and mixtures of these. The cyclic amide of component a1) is preferably caprolactam, laurolactam or a mixture of these. Lactam used is particularly preferably exclusively caprolactam or exclusively laurolactam.

For the purposes of the present invention, “activator” preferably means an activator for the anionic polymerization procedure, preferably a lactam N-substituted by electrophilic moieties (e.g. an acyllactam) or a precursor for an activated N-substituted lactam of this type, where this together with the cyclic amide forms an activated lactam in situ.

Suitable activators are compounds selected from the group of the isocyanates, uretdiones, carbodiimides, anhydrides and acyl halides and reaction products of these with the monomer.

Compounds suitable as activator of component a1) are in particular aliphatic diisocyanates, for example butylene diisocyanate, hexamethylene diisocyanate, octamethylene diisocyanate, decamethylene diisocyanate, undecamethylene diisocyanate, dodecamethylene diisocyanate, methylenebis(cyclohexyl 4-isocyanate), isophorone diisocyanate, aromatic diisocyanates, for example tolylene diisocyanate, methylenebis(phenyl 4-isocyanate), or polyisocyanates (e.g. isocyanates of hexamethylene diisocyanate), or allophanates (e.g. ethyl allophanate). In particular, mixtures of the compounds mentioned can be used as activator of component a1).

Other suitable activators are aliphatic diacyl halides, for example butylenedioyl chloride, butylenedioyl bromide, hexamethylenedioyl chloride, hexamethylenedioyl bromide, octamethylenedioyl chloride, octamethylenedioyl bromide, decamethylenedioyl chloride, decamethylenedioyl bromide, dodecamethylenedioyl chloride, dodecamethylenedioyl bromide, 4,4′-methylenebis(cyclohexyloyl chloride), 4,4′-methylenebis(cyclohexyloyl bromide), isophoronedioyl chloride, isophoronedioyl bromide, and also aromatic diacyl halides, for example tolylenemethylenedioyl chloride, tolylenemethylenedioyl chloride, 4,4′-methylenebis(phenyloyl) chloride, 4,4′-methylenebis(phenyloyl) bromide. In particular, mixtures of the compounds mentioned can be used as activator of component a1).

In particular, preference is given as activator of component a1) to at least one compound selected from the group consisting of aliphatic polyisocyanates, in particular diisocyanates, aromatic polyisocyanates, in particular diisocyanates, aliphatic diacyl halides and aromatic diacyl halides. The polyisocyanates, in particular aliphatic polyisocyanates, are preferably used in the form of blocked isocyanates.

In a preferred embodiment, at least one compound selected from the group of hexamethylene diisocyanate, isophorone diisocyanate, hexamethylenedioyl bromide, hexamethylenedioyl chloride and mixtures of these is used as activator of component a1). Hexamethylene diisocyanate is particularly preferably used as activator of component a1), in particular in the form of blocked of isocyanate. By way of example, a caprolactam-blocked hexamethylene 1,6-diisocyanate is suitable as activator. A solution of a caprolactam-blocked hexamethylene 1,6-diisocyanate in caprolactam—i.e. a mixture of component a1)—is obtainable commercially as Brueggolen® C20 from Brueggemann or Addonyl® 8120 from Rhein Chemic Rheinau GmbH.

The molar ratio of monomer, in particular of cyclic lactam, to activator can vary widely and is generally from 1:1 to 10000:1, preferably from 5:1 to 2000:1, particularly preferably 20:1 to 1000:1.

The monomer mixture a1) preferably comprises from 90 to 99% by weight of cyclic amide and from 1 to 10% by weight of activator.

a2)

It is preferable that cyclic amide used in component a2) is the same as cyclic amide used in component a1), and in particular that the former is likewise a cyclic amide of the general formula (I).

The catalyst is a familiar catalyst for the anionic polymerization reaction. For the purposes of the present invention, the expression “a catalyst for the anionic polymerization reaction” preferably means a compound which permits the formation of lactam anions.

The catalyst of component a2) for the polymerization of the cyclic amide is preferably a conventional catalyst for anionic polymerization, preferably being selected from the group consisting of sodium caprolactamate, potassium caprolactamate, magnesium bromide caprolactamate, magnesium chloride caprolactamate, magnesium biscaprolactamate, sodium hydride, sodium, sodium hydroxide, sodium methanolate, sodium ethanolate, sodium propanolate, sodium butanolate, potassium hydride, potassium hydroxide, potassium methanolate, potassium ethanolate, potassium propanolate and potassium butanolate, preferably from group consisting of sodium hydride, sodium and sodium caprolactamate, particularly preferably being sodium caprolactamate.

It is also possible to use, as monomer mixture of component a2) comprising a catalyst, a solution of sodium caprolactamate in caprolactam, e.g. Brüggolen® C10 from Brüggemann, which comprises from 17 to 19% by weight of sodium caprolactamate in caprolactam or Addonyl® Kat NL from Rhein Chemie Rheinau GmbH, which comprises 18% by weight of sodium caprolactamate in caprolactam.

The molar ratio of cyclic amide to catalyst can vary widely, generally being from 1:1 to 10000:1, preferably from 5:1 to 1000:1, particularly preferably from 1:1 to 500:1.

The monomer mixture a2) preferably comprises from 80 to 99% by weight of cyclic amide and from 1 to 20% by weight of catalyst. The monomer mixture a2) particularly preferably comprises more than 96% by weight of cyclic amide and less than 4% by weight of catalyst.

Application

The temperature at which the two monomer mixtures a1) and a2) are applied to the fiber material is preferably up to 140° C., preferably up to 100° C. above the melting point. The total quantity of the mixtures a1) and a2) preferably applied here is from 10 to 100 g per 100 g of weight per unit area of the fiber material, in particular from 30 to 50 g per 100 g.

Various application devices can be used in order to achieve the desired particle size. The two mixtures a1) and a2) can respectively be applied to the fiber material simultaneously or in succession, but preferably simultaneously, in particular in conjunction with identical proportions by volume of a1) and a2). Preferred applicators that can be used here are single-fluid nozzles, two-fluid nozzles, multiple-fluid nozzles and rotating nozzles.

Supply to an applicator is preferably achieved by means of a pump, preferably a displacement pump, gear pump or distance metering pump, via temperature-controlled lines, preferably with volume-flow-rate control, at a temperature T that is preferably from 100 to 180° C., where the two containers comprising the respective monomer mixtures a1) and a2) have respectively been equipped with conveying equipment of this type. In the case of inert-gas-induced actimization, the function of the metering pumps is merely to supply components a1) and a2) to the nozzle(s) at defined volume flow rates.

The ratio of the metered volume flow rates of components a1) and a2) is preferably from 4 to 0.25, particularly preferably from 1.1 to 0.9.

The use of a multiple-fluid nozzle, in particular a three-fluid nozzle, has proven particularly successful.

Two melt streams of components a1) and a2) are discharged and dropletized by means of an inert gas stream, preferably a nitrogen stream, by way of the three-fluid nozzle. The temperature T at which the inert gas is supplied to the multiple-fluid nozzle is preferably from 140 to 160° C.

A further advantage in use of a multiple-fluid nozzle, in particular of a three-fluid nozzle, is that it can form sufficiently small droplets of the discharged melts of component a1) and a2). The inert gas, preferably nitrogen, emerging from the nozzle here provides the kinetic energy for the production of appropriately small droplets. The droplet size can preferably be measured here by using laser diffraction spectrometers. The flight path and velocity can by way of example be influenced via the conditions prevailing at the nozzle, the direction of gravitational force and the inert gas flow rate and via electrostatic forces, and also via combinations of these controllable variables, with the aim of applying the droplets to the fiber material in the most suitable manner.

In order to avoid spraying losses, it is preferable that as the inert gas is removed by suction or other means it passes through the, preferably continuously supplied, fiber material, whereupon, by virtue of forced convection, in particular the fine fraction of the melt droplets is removed by filtration by the fiber material; it is thus possible to minimize spraying losses that would otherwise occur. The fiber material here in practice functions as filter material. In a simultaneous ancillary effect, this removal of inert gas by suction through the fiber material provides further drying of said material.

It is preferable that fiber material is located below the applicator and is introduced with constant intake velocity in production direction in the continuous operation. It is preferable that the process of the invention is carried out continuously.

The activated monomer melt required for the anionic polymerization reaction is formed in the process of the invention via the coalescence and mixing of the droplets of the two components a1) and a2).

b) Polymerization

The monomer melts a1) and a2) applied to the fiber material are preferably polymerized at a temperature of from 120 to 300′C, preferably from 120 to 250° C., in particular at from 140 to 180° C.

The process of the invention can be further improved in that, after the application of the two components a1) and a2), the impregnated fiber material is subsequently exposed to pressure, which is constant or alternating (for which the term pounding is sometimes used).

For this it is preferable, after the application of a1) and a2), to cover the fiber material with circulating belts, preferably using polytetrafluorethylene, and to introduce said material into a continuously operated heated press device. Alternatively, this type of pressure can also be achieved by means opposing roll pairs. The pressure is preferably from 2 to 100 bar, particularly preferably from 10 to 40 bar.

The temperature to be used during the application of pressure is preferably higher than the melting point of components a1) and a2), preferably up to 140° C., in particular up to 100° C. higher.

The pounding procedure, preferably with the aid of opposing roll pairs, induces relative movements producing shear, extension and compression, and thus provides additional assistance in achieving even more intimate mixing of components a1) and a2) and better distribution thereof in the fiber material. The preferred simultaneous application of components a1) and a2) and inert gas by way of a multiple-fluid nozzle achieves efficient inertization of the spray mist, thus preventing deactivation of the melt, for example by atmospheric moisture.

The three-fluid nozzle that is preferably used in the invention can provide average droplet diameters of about 30-100 μm; the average mass of a droplet measuring 70 μm is then about 0.2 mg, i.e. about 1/1000^{th} of the mass of a droplet obtained primarily via gravitational force.

The process of the invention preferably provides a fiber composite material with less than 3%, residual monomer content, preferably less than 2%.

In the case of continuous systems, residual monomer contents below 1% by weight are possible.

The process of the invention has particularly good suitability for semicontinuous or continuous processes, preferably in twin-belt presses or in continuous molding presses.

The process of the invention features rapid impregnation and high productivity and permits high-speed production of fiber composite materials.

The process of the invention can also be used for the production of fiber composite materials with multilayer fiber material.

Preference is given to this type of process for the production of a fiber composite material comprising a plurality of plies of fiber material, characterized in that
i) a plurality of plies of fiber material are mutually superposed and the surface of the uppermost ply is treated in step a) with the monomer mixtures a1) and a2) before step b) follows or
ii) a plurality of plies of fiber material are first individually treated as in step a) with the monomer mixtures and these are then brought into contact preferably with application of pressure, before step b) follows.

When a plurality of plies of fiber material are used, it is preferable to apply pressure during the subsequently polymerization procedure in order to maintain the greatest possible intimacy of contact between the plies of fiber material and the developing polymer matrix.

It is moreover possible to obtain a multilayer fiber composite material by pressing the fiber composite materials obtained by the process of the invention, using single- or multilayer fiber material, with other such fiber composite materials at a temperature in the region of the melting point or softening point of the polymer matrix, in particular from 10 to 80° C. preferably from 10 to 60° C. above the melting point or softening point.

The invention therefore also provides a process for the production of a single- or multilayer fiber composite material.

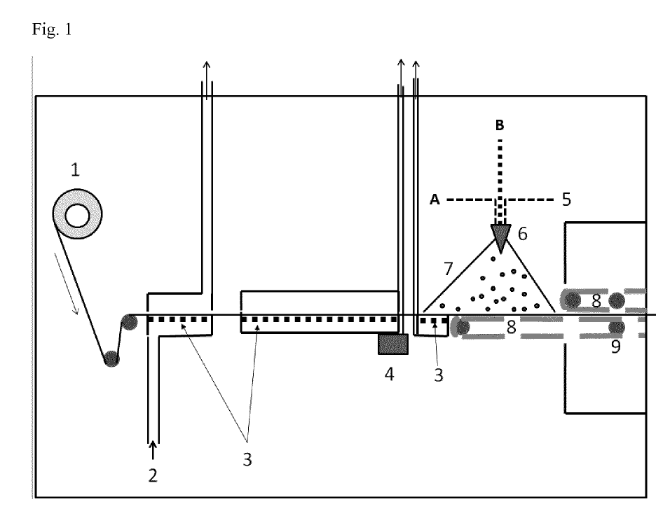

FIG. 1 depicts a preferred arrangement of a continuously operated system for the operation of the process of the invention.

### ELEMENTS OF FIG. 1

(1) Fiber material (supply from a roller)
(2) Hot air for the predrying procedure
(3) Perforated metal sheets for air ingress
(4) Hot dry air in circulation
(5) Preheated nitrogen
(6) Three-fluid nozzle
(7) Dome structure (spray-zone housing)
(8) Teflon transport belt
(9) Opposing rollers to compress fiber material
(A) Caprolactam with activator
(B) Caprolaciam with catalyst

### EXAMPLES

1. Experiments relating to the effect of melt-application procedure and of droplet size:

a1)

100 g of ε-caprolactam and 6.5 g of Addonyl® Kat NL (Rhein Chemie Rheinau GmbH) catalyst were weighed into a three-necked flask. Addonyl Kat NL is a commercially available mixture of 18.5% by weight of sodium caprolactamate (CAS No.: 2123-24-2) in monomeric caprolactam.

a2)

100 g of ε-caprolactam and 3.5 g of Addonyl® 8120 (likewise from Rhein Chemie Rheinau GmbH) were charged to a second three-necked flask. Addonyl 8120 is a bilaterally caprolactam-blocked hexamethylene diisocyanate, specifically N,N′-hexane-1,6-diylbis(hexahydro-2-oxo-1H-azepine-1-carboxamid), CAS No.: 5888-87-9.

The contents of the two flasks were melted separately in oil baths preheated to 135° C. Vacuum was then applied at this temperature for 10 minutes. The two flasks were then blanketed with nitrogen, and the oil baths were removed.

The melts a1) and a2) were respectively cooled until the temperature of melts was 100° C.

The experiments were carried out by hotplate, which was enclosed with foil for inertization and the internal cavity of which was blanketed with nitrogen. Specifically, the dry nitrogen was charged to the internal cavity and the temperature of the hotplate was controlled to 160° C.

A woven glassfiber fabric (P-D Interglas Technologies, Erbach, type 92152 with weight per unit area 290 g/m²) was predried in an oven at 80° C. for 12h.

The desired fiber content by volume of the fiber composite material in the experiments was 40%. The textile plies used for the experiments were first weighed, in order to permit calculation of the volume of melt required to achieve the 40% fiber ratio by volume.

In order to improve heat conduction, an iron plate (mass: 2.0 kg) likewise controlled to a temperature of 160° C. was placed from above onto the impregnated woven fabric after melt application. In order to avoid direct contact between the melt and the iron plate, the woven glassfiber fabric was covered with a polyimide foil (Kaptan® HN from DuPont) after melt application.

Polymerization time was 5 minutes in all cases.

### Comparative Example 1

The two prepared caprolactam melts a1) and a2) were combined and mixed, and then a preheated PE pipette was used to apply the quantity calculated to achieve 40% fiber content by volume.

The residual monomer content of the PA 6 Matrix after polymerization was 1.9% by weight.

### Comparative Example 2

The two prepared caprolactam melts a1) and a2) were not combined, but instead two preheated PE pipettes were used to apply equal volumes thereof separately to the woven glassfiber fabric. Droplets of the two melts were applied here simultaneously, and the droplets were applied in the immediate vicinity of the respective other component in order to achieve the best possible mixing.

The average mass of an individual droplet formed here under the influence of gravitational force was 20 mg.

The residual monomer content of the PA 6 Matrix after polymerization was 80% by weight, and it was therefore composed mainly of unreacted monomer, which could be leached out of the composite sheet by warm water.

### Comparative Example 3

The procedure was as in comparative example 2, but after application of the two melts a1) and a2) the woven fabric was covered with a polyimide foil and rolled, i.e. “pounded”, by a single roller for 5 seconds.

The residual monomer content of the PA 6 Matrix after polymerization was 50% by weight, and it was therefore still composed mainly of unreacted monomer.

### Example 1 (of the Invention)

In this case, the two melts were applied at identical volume flow rates by way of a 946 S1 three-fluid nozzle from Schlick. In order to avoid solidification of the caprolactam melts, the temperature of the nozzle was controlled in advance to 120° C. in an oven, the materials were metered at identical volume flow rates by way of two preheated PE spray devices, and atomization achieved via a current of nitrogen (30% by weight of nitrogen, based on the total quantity of melt metered).

This method can achieve droplet diameters <100 μm. Average droplet mass was therefore about 1/1000^{th} of that in the variant described in comparative example 2.

The residual monomer content of the PA 6 Matrix after polymerization was only 2.5% by weight. In addition to this, no problematic polymer deposits were discernible.

1. A process for the production of a fiber composite material, the process comprising:
a) applying to the surface of a fiber material:
a1) droplets of a first monomer mixture that is liquid at the application temperature, the first monomer mixture comprising a cyclic amide and an activator, and
a2) droplets of a second monomer mixture that is liquid at the application temperature, the second monomer mixture comprising a cyclic amide and a catalyst,
at a temperature above the melting point, and
b) polymerizing the monomer mixtures in a) at a temperature of 120 to 300° C.,
wherein the average droplet size of the droplets of the respective monomer mixtures a1) and a2) is less than 500 μm.

2. The process for the production of the fiber composite material as claimed in claim 1, wherein the cyclic amide is laurolactam, caprolactam or a mixture of these.

3. The process for the production of a fiber composite material as claimed in claim 1, wherein the activator comprises at least one compound selected from the group of the isocyanates, uretdiones, carbodiimides, anhydrides, acyl halides, and reaction products of these with the monomer.

4. The process for the production of a fiber composite material as claimed in claim 1, wherein the catalyst comprises at least one compound selected from the group consisting of sodium caprolactamate, potassium caprolactamate, magnesium bromide caprolactamate, magnesium chloride caprolactamate, magnesium biscaprolactamate, sodium hydride, sodium, sodium hydroxide, sodium methanolate, sodium ethanolate, sodium propanolate, sodium butanolate, potassium hydride, potassium hydroxide, potassium methanolate, potassium ethanolate, potassium propanolate and potassium butanolate.

5. The process for the production of a fiber composite material as claimed in claim 1, characterized in that the fiber material is selected from the group of the woven fabrics, laid scrims inclusive of multiaxial laid scrims, knitted fabrics, braided fabrics, nonwoven fabrics, felts, and mats.

6. The process for the production of fiber composite material as claimed in claim 1, when the droplets of the monomer mixtures are applied by means of a three-fluid nozzle.

7. The process for the production of a fiber composite material as claimed in claim 1, wherein the fiber material comprises a plurality of plies of fiber material, superposed on one another with an uppermost ply, and the process further comprises:
i) treating the surface of the uppermost ply in step a) with the monomer mixtures a1) and a2) before step b) follows, or
ii) individually treating each of the plurality of plies of fiber material in step a) with the monomer mixtures, and placing the treated plies into contact with one another before step b) follows.

8. The process for the production of the fiber composite material as claimed in claim 1, wherein the average droplet size of the droplets of the respective monomer mixtures a1) and a2) is less than 200 μm.

9. The process for the production of the fiber composite material as claimed in claim 1, wherein the average droplet size of the droplets of the respective monomer mixtures a1) and a2) is 10 to 100 μm.

10. The process for the production of the fiber composite material as claimed in claim 1, wherein:
the cyclic amide is laurolactam, caprolactam or a mixture of these;
the activator comprises at least one compound selected from the group of the isocyanates, uretdiones, carbodiimides, anhydrides, acyl halides, and reaction products of these with the monomer; and
the catalyst comprises at least one compound selected from the group consisting of sodium caprolactamate, potassium caprolactamate, magnesium bromide caprolactamate, magnesium chloride caprolactamate, magnesium biscaprolactamate, sodium hydride, sodium, sodium hydroxide, sodium methanolate, sodium ethanolate, sodium propanolate, sodium butanolate, potassium hydride, potassium hydroxide, potassium methanolate, potassium ethanolate, potassium propanolate and potassium butanolate.

11. The process for the production of the fiber composite material as claimed in claim 10, wherein:
the catalyst comprises at least one of sodium hydride, sodium and sodium caprolactamate;
the fiber material comprises a plurality of layers of fiber material and the fiber material is selected from the group of the woven fabrics, laid scrims inclusive of multiaxial laid scrims, knitted fabrics, braided fabrics, nonwoven fabrics, felts, and mats; and
the average droplet size of the droplets of the respective monomer mixtures a1) and a2) is 10 to 100 μm.
